(19) United States
(12) Patent Application Publication
(10) Pub. No.: US 2024/0187839 A1
(43) Pub. Date: Jun. 6, 2024

(54) SYSTEMS AND METHODS FOR MULTI-OPERATOR PROFILE MANAGEMENT

(71) Applicant: Verizon Patent and Licensing Inc., Basking Ridge, NJ (US)

(72) Inventors: Matthew B. Whited, Encinitas, CA (US); Niranjan R. Samant, Lansdale, PA (US); Firas Behjet Arabo, Spring Valley, CA (US); Fang-Pin Chang, San Marcos, CA (US); Meeta P. Kherdekar, Des Plaines, IL (US); Manavendra Nath Rai Chalasani, San Diego, CA (US)

(73) Assignee: Verizon Patent and Licensing Inc., Basking Ridge, NJ (US)

(21) Appl. No.: 18/061,655

(22) Filed: Dec. 5, 2022

(51) Int. Cl. H04W 8/18; H04W 60/00

(52) U.S. Cl. CPC H04W 8/183; H04W 60/00

(57) ABSTRACT

A device described herein may maintain a sets of service parameters respectively associated with multiple networks. The device may receive a request, including may include an identifier of a User Equipment (“UE”), to register the UE with a particular network. The device may identify, based on the request, a particular set of service parameters associated with the particular network, and may output an indication, to the particular network, indicating the identifier of the UE and the identified particular set of service parameters. The particular network may select or generate a set of network credentials based on receiving the indication, which may be used by the UE to access the particular network. The particular network may provide service to the UE in accordance with the particular set of service parameters.

### BACKGROUND

Wireless networks may provide services to User Equipment (“UEs”), such as mobile telephones, Internet of Things (“IoT”) devices, or other wireless devices. Different wireless networks may be owned and/or operated by different entities, or operators. A UE may include a SIM (“Subscriber Identification Module”) card or other type of mechanism which may be associated with a profile, an identity, a set of credentials, or other suitable information that the UE may use to access a particular wireless network associated with a particular operator.

### BRIEF DESCRIPTION OF THE DRAWINGS

FIG. 1 illustrates an example overview of one or more embodiments described herein;

FIGS. 2 and 3 illustrate examples of service parameters and/or policies associated with one or more networks, in accordance with some embodiments;

FIG. 4 illustrates an example provisioning of a UE to access a first network;

FIGS. 5A, 5B, 6A, and 6B illustrate an example provisioning of a UE to access a second network, in accordance with some embodiments;

FIGS. 7 and 8 illustrate examples of a UE using a selected profile to access different networks;

FIG. 9 illustrates an example process for facilitating the provisioning of a UE with one or more networks, in accordance with some embodiments;

FIG. 10 illustrates an example environment in which one or more embodiments, described herein, may be implemented;

FIG. 11 illustrates an example arrangement of a radio access network (“RAN”), in accordance with some embodiments; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Different wireless networks, that are owned, operated, and/or otherwise associated with different operators, may implement diverse protocols, messaging schemes, application programming interfaces (“APIs”), etc., via which UEs may be registered, provisioned, and/or otherwise associated with such wireless networks. For example, a first wireless network may utilize a Representational State Transfer (“REST”) protocol to register UEs for use with the first wireless network, a second wireless network may utilize a Simple Text Orientated Messaging Protocol (“STOMP”) to register UEs for use with the second wireless network, and so on.

Some UEs may be able to be registered with multiple wireless networks. One such UE may, for example, utilize a first profile when communicating with a first wireless network and may utilize a second profile when communicating with a second wireless network. The first profile may include, for example, one or more identifiers, authentication tokens, network credentials, etc. that are maintained by or are otherwise identifiable by the first wireless network in order to identify and/or authenticate the UE for use with the first wireless network. Similarly, the second profile may include one or more identifiers, authentication tokens, network credentials, etc. that are maintained by or are otherwise identifiable by the second wireless network in order to identify and/or authenticate the UE for use with the second wireless network. Some such UEs may, for example, include one or more dual or multi SIM cards, one or more removable SIM cards, one or more embedded SIM (“eSIM”) cards, one or more cards or mechanisms that utilize one or more Universal SIM (“USIM”) file systems (e.g., which may include a single card that utilizes multiple USIM file systems), some other type of storage device, and/or a combination thereof. In some embodiments, one such UE may implement a Dual SIM Dual Standby (“DSDS”) standard or some other suitable standard, protocol, API, etc. that allows the UE to maintain and select between (e.g., switch between) multiple different profiles.

One particular profile may be “active” at any given time, where other profiles may be “idle,” “inactive,” etc. When communicating with a given wireless network, the UE may utilize the active profile, which may include providing identifiers, network credentials, etc. associated with the active profile to the wireless network in order to obtain access (e.g., wireless connectivity) to the wireless network.

Operators of different wireless networks may communicate with each in order to register UEs with other networks. Since different operators may utilize different protocols, APIs, messaging schemes, etc., as discussed above, the complexity of coordinating between such operators may become relatively burdensome and may hinder the interoperability between networks. Embodiments described herein provide for simplified techniques whereby UEs, such as UEs that support multiple profiles associated with multiple networks, may be registered with multiple wireless networks associated with multiple operators via a unified interface, thus reducing or eliminating the need for specialized communications between network operators.

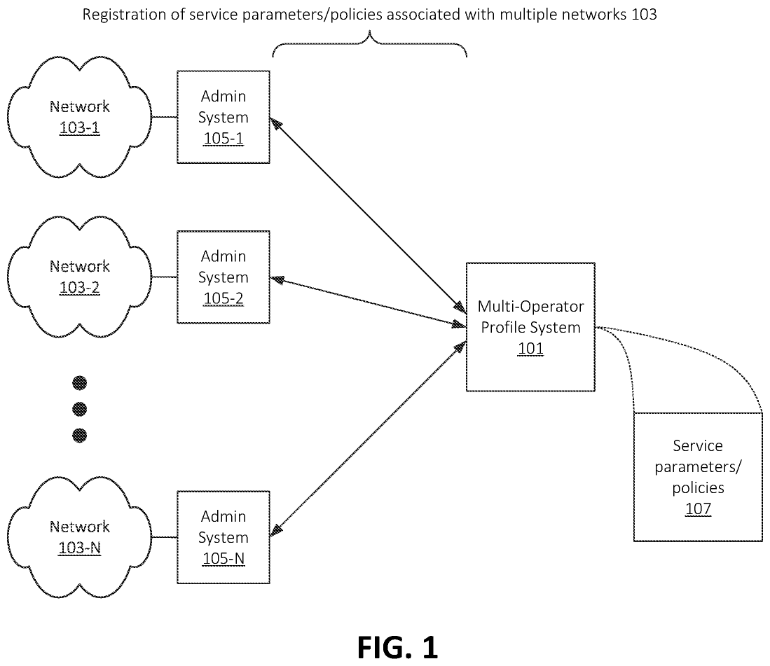

As shown in FIG. 1, for example, a Multi-Operator Profile System (“MOPS”) 101 of some embodiments may be communicatively coupled to one or more networks 103, such as networks 103-1, 103-2, 103-N, etc. MOPS 101 may include, may be implemented by, may be communicatively coupled to, and/or may otherwise be associated with a cloud computing system, an application server, and/or some other suitable type of device or system. In some embodiments, MOPS 101 may communicate with networks 103 via the Internet and/or some other suitable type of network or communication pathway. MOPS 101 may, for example, be associated with an application programming interface (“API”), a web portal, or some other suitable communication pathway via which networks 103 and/or other devices or systems may communicate with MOPS 101 in order to facilitate operations discussed herein.

Networks 103 may be, may include, may implement, etc. wireless networks, such as RANs (e.g., a Long-Term Evolution (“LTE”) RAN, a Fifth Generation (“5G”) RAN, and/or some other type of RAN), core networks (e.g., an Evolved Packet Cores (“EPC”), a 5G Core (“5GC”), and/or some other type of core network), and/or some other type of network. Networks 103 may each be operated by, provided by, and/or otherwise associated with a respective network operator or other type of entity that manages, controls access to, maintains, configures, and/or performs other suitable operations with respect to such networks 103.

Each network 103 may be associated with a respective administration (“admin”) system 105, which may be used to register, provision, etc. UEs or other devices for use with a particular network 103. For example, admin system 105-1 may register UEs for use with network 103-1, admin system 105-2 may register UEs for use with network 103-2, and so on. As referred to herein, registering, provisioning, etc. a UE for use with a particular network 103 may include authenticating the UE, determining that the UE is authorized to be registered with network 103, determining service parameters for the UE such as types or amounts of traffic that the UE is authorized to send or receive via network 103, and/or other suitable operations. Registering a given UE for use with a particular network 103 may include generating, provisioning, etc. a set of authentication credentials that may be used by the UE when attempting to access the particular network 103. Admin system 105 and/or some other device or system may provide such authentication credentials to the UE (e.g., via an Over-the-Air (“OTA”) update procedure, via an initial setup procedure, and/or at some other time), and the UE may maintain such authentication credentials (e.g., in a SIM card, an eSIM, etc.) for use when attempting to access network 103.

Although referred to herein as an “admin system,” in some implementations, different networks 103 may include or may be communicatively coupled to other types of devices or systems that perform similar operations, such as a provisioning system, a management system, etc. In such implementations, the operations described herein with respect to admin system 105 may be performed by a provisioning system, a management system, or other suitable device or system associated with a given network 103.

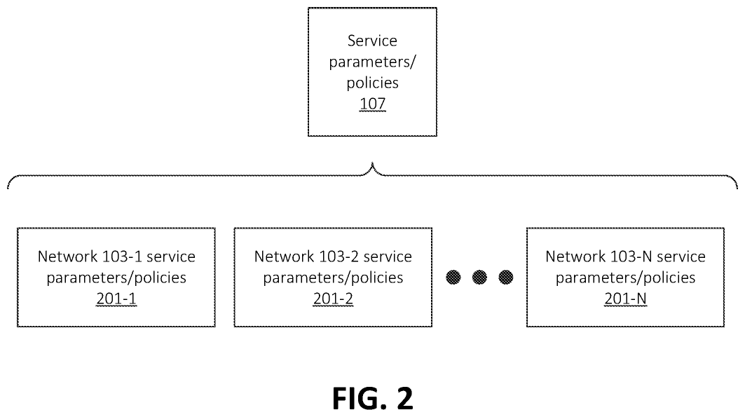

As noted above, admin systems 105, associated with networks 103, may communicate with MOPS 101 via an API, web portal, or other suitable communication pathway. Admin systems 105 may register, in some embodiments, service parameters and/or policies, associated with respective networks 103, with MOPS 101. MOPS 101 may accordingly maintain service parameters and/or policies 107, associated with networks 103. For example, as shown in FIG. 2, service parameters and/or policies 107, as maintained by MOPS 101, may include respective service parameters and/or policies 201 associated with each respective network 103, such as service parameters and/or policies 201-1 associated with network 103-1, service parameters and/or policies 201-2 associated with network 103-2, and so on. As discussed below, MOPS 101 may use service parameters and/or policies 107 in order to facilitate the provisioning of a given UE across multiple networks 103, as discussed below (e.g., MOPS 101 may identify a particular set of service parameters and/or policies 201 associated with a particular network 103 when facilitating the registration, provisioning, etc. of one or more UEs with the particular network 103).

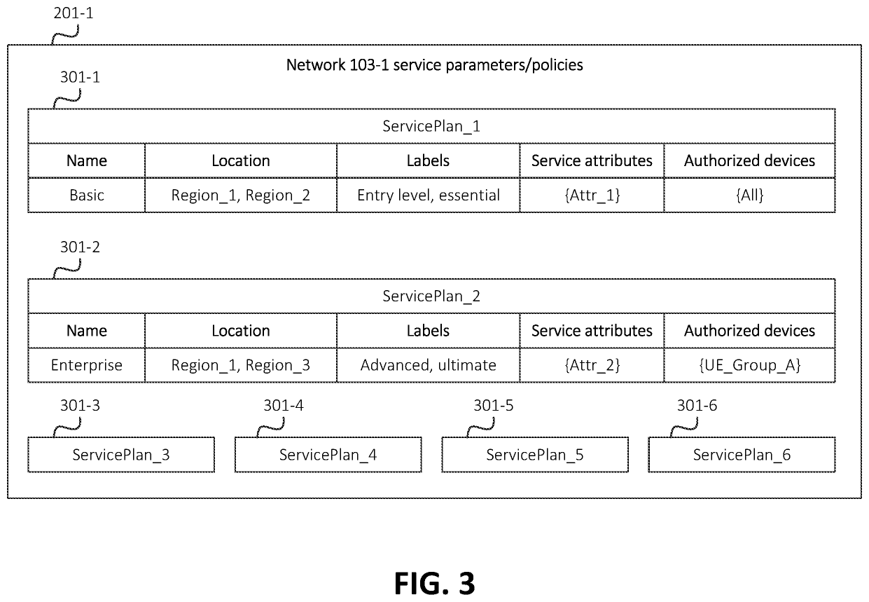

In some embodiments, service parameters and/or policies 201, associated with a given network 103, may include distinct sets of service parameters (referred to herein as “service plans” for the sake of brevity). For example, as shown in FIG. 3, service parameters and/or policies 201-1, associated with network 103-1, may include service plans 301-1 through 301-6.

Each service plan 301 may include a set of service attributes, which may define Quality of Service (“QoS”) parameters (e.g., network slices, priority levels, 5G QoS Identifier (“5QI”) values, etc.), authorized or unauthorized service parameters (e.g., indicating types of traffic, applications, or services such as voice, data, etc., that are allowed or disallowed under a certain service plan), dates or times at which certain parameters apply (e.g., a first set of QoS parameters during weekdays and a second set of QoS parameters during weekends), and/or other attributes of service to be provided via network 103-1. For example, service plan 301-1 may include a first set of service attributes, represented in FIG. 3 as “{Attr_1},” service plan 301-2 may include a second set of service attributes “{Attr_2},” and so on.

Service plans 301 may, in some embodiments, indicate a set of devices (e.g., UEs) that are authorized to use respective service plans 301. For example, service plan 301-2 may indicate that only UEs that are in a particular group (e.g., “{UE_Group_A}”) are authorized to use service plan 301-2, while service plan 301-1 may indicate that service plan 301-1 may be used by any UE. For example, service plan 301-2 may be a relatively high priority or more costly service plan that is available to UEs of a particular group or organization, while service plan 301-1 may be a more generally available service plan for use with network 103-1.

The “authorized devices” field, for a given service plan 301, may include UE identifiers, such as International Mobile Subscriber Identity (“IMSI”) values, Mobile Directory Numbers (“MDNs”), International Mobile Station Equipment Identity (“IMEI”) values, Internet Protocol (“IP”) addresses, or other types of UE identifiers. Additionally, or alternatively, UEs or groups of may be specified based on device type, location, or other suitable criteria.

Service plans 301 may additionally include information indicating a location, time, or other criteria based on which respective service plans 301 are associated. For example, service plan 301-1 may include information indicating that service plan 301-1 is associated with “Region_1” and “Region_2” (e.g., which may refer to geographical locations, cells of a RAN, physical addresses, or other suitable indicators of location), and service plan 301-2 may include information indicating that service plan 301-2 is associated with “Region_1” and “Region_3.” For example, a UE that is located in Region_3 may potentially receive service according to service plan 301-2, but may not be eligible to receive service according to service plan 301-1, as UE is outside of the specified locations associated with service plan 301-1.

Service plans 301 may also include other information that may be used to identify or otherwise indicate attributes associated with service plans 301, such as names, labels, tags, categories, etc. In some embodiments, service plans 301 may further include additional and/or different information than the examples discussed in FIG. 3. As discussed below, some or all of the information, associated with respective service plans 301, may be used when registering a given UE to access a given network 103.

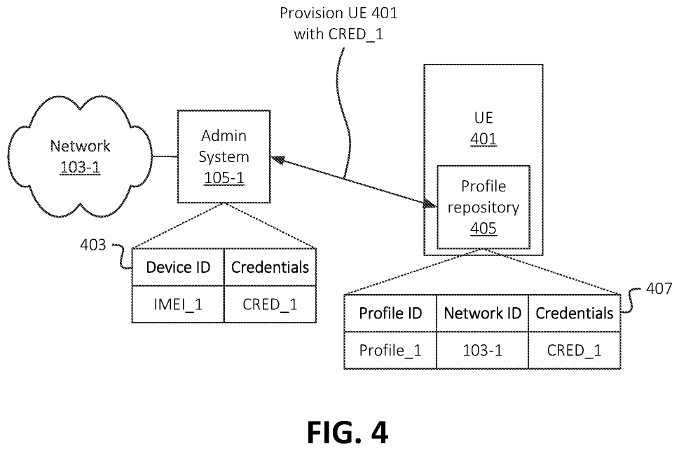

FIG. 4 illustrates an example of registering, provisioning, etc. a given UE 401 with network 103-1. As shown, admin system 105-1 may provision UE 401 to use network 103-1, which may include authenticating UE 401, determining service parameters associated with 401 when accessing network 103-1, and/or other suitable operations. Provisioning UE 401 to use network 103-1 may include generating, selecting, and/or otherwise determining a particular set of network credentials (represented as “CRED_1”) that UE 401 may use to access network 103-1.

Provisioning UE 401 may include generating or maintaining, by admin system 105-1, data structure 403, associating UE 401 with the provisioned set of network credentials (i.e., CRED_1 in this example). Data structure 403 may, in some embodiments, include the network credentials themselves (e.g., a Ki credential, an OP key, or some other type of credential), or may include an identifier or value based on which the network credentials may be identified or derived (e.g., an IMSI, a Subscription Permanent Identifier (“SUPI”), a Globally Unique Temporary Identifier (“GUTI”), etc.).

Data structure 403 may include an identifier of UE 401 (represented as “IMEI_1”). The identifier of UE 401 may be a non-portable identifier, a device identifier, a hardware identifier, and/or other suitable identifier that identifies UE 401. The identifier may, for example, be tied to UE 401 itself such that the identifier may be considered as a unique identifier for UE 401 that cannot be changed or ported to another device. For example, the UE identifier may include an IMEI value, a serial number, and/or other suitable type of unique identifier. Although data structure 403 is shown as including one entry for UE 401 (e.g., having device identifier “IMEI_1”), data structure 403 may, in practice, store multiple (e.g., hundreds, thousands, or more) entries for multiple UEs. Further, data structure 403 may include additional or different information, such as a Mobile Directory Number (“MDN”) for UE 401, an IMSI value, an IP address, and/or other suitable information.

In some embodiments, admin system 105-1 may provide some or all of the information in data structure 403 to one or more elements of network 103-1, such as a Unified Data Management function (“UDM”), a Home Subscriber Server (“HSS”), a charging system, or other suitable elements of network 103-1. In some embodiments, admin system 105-1 may communicate with such elements of network 103-1 via a Service Capability Exposure Function (“SCEF”), a Network Exposure Function (“NEF”), or some other suitable communication pathway.

UE 401 may receive an indication of the provisioning of UE 401 for use with network 103-1, which may include receiving the network credentials and/or other suitable information. For example, UE 401 may receive such provisioning information from admin system 105-1 (e.g., via network 103-1 and/or some other network) and/or from some other suitable device or system. In some embodiments, UE 401 may receive the provisioning information via an OTA update procedure, during an initial setup procedure, and/or at some other time.

UE 401 may include profile repository 405, which may be, may include, may be implemented by, etc. one or more UICCs, one or more SIM cards, one or more dual or multi SIM cards, one or more eSIM cards, etc., as discussed above. The information stored by profile repository 405 may be represented as data structure 407, which may store one or more profiles associated with UE 401. Each profile, as referred to herein, may be associated with a particular set of network credentials, which may include or may otherwise be associated with an IMSI value, a SUPI, GUTI, and/or some other suitable type of identifier or credential that may be used by UE 401 to communicate with a respective network 103.

UE 401 (e.g., profile repository 405 or some other component of UE 401) may maintain information indicating a “master” network 103 and/or admin system 105 (e.g., a network identifier of the master network 103, an IP address or other identifier of the master admin system 105, etc.). The master network 103 may be authorized to request or initiate modifications to modify profile repository 405 (e.g., data structure 407), which may include modifications based on communicating with MOPS 101 in order to register, provision, etc. UE 401 with one or more other networks 103. In some embodiments, the master network 103 and/or admin system 105 may have access to read, determine, etc. some or all profile information maintained in profile repository 405, which may include identifying particular profiles that are installed or otherwise included in profile repository 405, identifying respective networks 103 that are associated with such profiles, identifying which profile is active and which profile(s) is/are inactive, etc. On the other hand, other networks 103 and/or admin systems 105 (e.g., other than the master network 103 and/or admin system 105) may not have access to read or otherwise identify profiles, maintained in profile repository 405, that are associated with other networks 103.

In some embodiments, provisioning UE 401 for access to network 103-1 may include providing, by admin system 105-1 or some other device or system, an indication to MOPS 101 that network 103-1 is a “master” network with respect to UE 401 and/or profile repository 405. For example, MOPS 101 may maintain information associating one or more identifiers of UE 401 (e.g., an IMEI value or some other suitable identifier) with an identifier of network 103-1 and/or admin system 105-1. In some embodiments, profile repository 405 may include a flag, indicator, etc. indicating that network 103-1 is a master network with respect to UE 401 and/or profile repository 405.

In instances where profile repository 405 includes multiple different profiles, one particular profile may be “active” while the other profiles are “inactive,” “idle,” etc. When a given profile is active, UE 401 may utilize credentials associated with the active profile to communicate with one or more networks 103. UE 401 may “utilize” such credentials inasmuch as UE 401 may include such credentials in control plane signaling (e.g., registration requests, session establishment requests, etc.) and/or user plane signaling (e.g., outputting user plane traffic such as voice traffic, data traffic, etc.) sent by UE 401 and/or may use such identifiers to identify traffic sent to UE 401 from one or more networks 103.

In some embodiments, profile repository 405 may include authentication mechanisms whereby only authorized devices or systems may modify information stored by profile repository 405 (e.g., modify data structure 407). For example, profile repository 405 and/or some other element of UE 401 may verify that provisioning information (e.g., provisioning UE 401 for use with one or more networks 103) is received from admin system 105-1 prior to updating data structure 407 with such provisioning information. In some embodiments, provisioning UE 401 for use with network 103-1 may include selecting a particular service plan associated with network 103-1, which may include communicating with admin system 105-1 to select or otherwise specify a particular service plan indicating service parameters for UE 401 when UE 401 communicates with network 103-1.

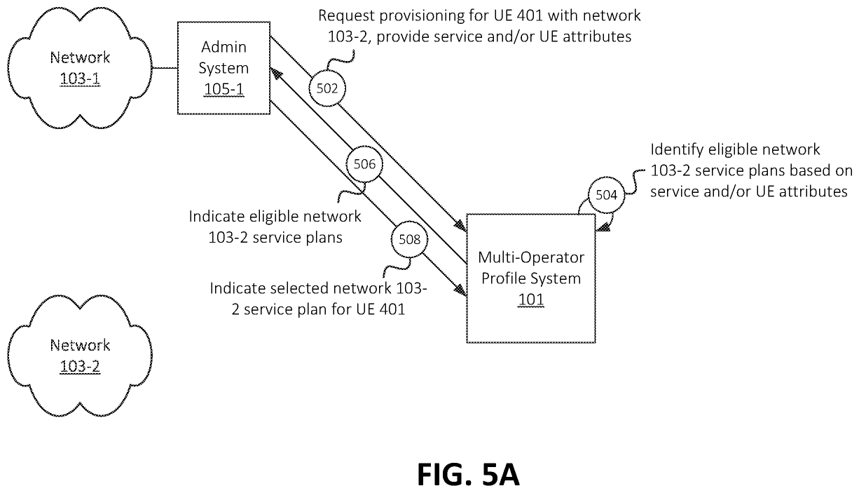

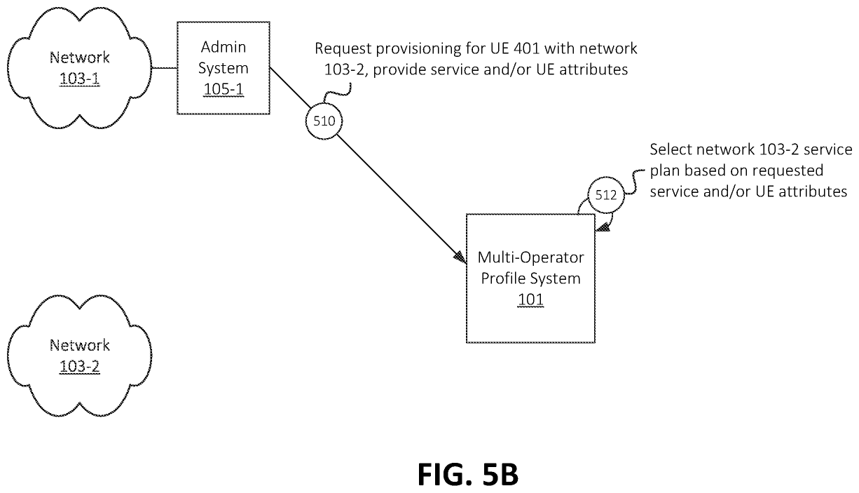

FIGS. 5A and 5B illustrate examples of requesting that UE 401 be provisioned for use with network 103-2 (e.g., in addition to network 103-1). As shown in FIG. 5A, admin system 105-1 may request (at 502) that UE 401 be provisioned for use with network 103-2. The request may include requested service and/or UE attributes. For example, admin system 105-1 may include a device identifier of UE 401 (e.g., an IMEI value or other device identifier), a device type of UE 401 (e.g., a mobile phone, a tablet, an IoT device, etc.), one or more categories or labels of UE 401 (e.g., “enterprise,” “first responder,” etc.), requested QoS parameters (e.g., latency thresholds, throughput thresholds, etc.), a requested set of traffic or service types (e.g., voice, data, augmented reality, semi-autonomous driving, etc.), and/or other suitable UE and/or service attributes. In some embodiments, the request may specify a particular location or region(s) for which access to network 103-2 is requested (e.g., a particular country, a particular region, etc.). In some embodiments, the request may include one or more query terms, natural language queries, and/or other information which may be analyzed or otherwise processed in order to determine requested service parameters associated with the request.

MOPS 101 may identify (at 504) eligible service plans 301 associated with network 103-2 based on the request. For example, MOPS 101 may identify particular service parameters and/or policies 201-2 associated with network 103-2, and may identify why which service plan or plans 301 satisfy the request. For example, MOPS 101 may compare service attributes, labels, location information, etc. associated with one or more service plans 301, with which network 103-2 is associated, to information included in the request. In some embodiments, the request may include structured data or may otherwise indicate particular values that may be compared to values included in service parameters and/or policies 201-2 associated with network 103-2. Additionally, or alternatively, the request may include unstructured data, natural language, etc. that does not necessarily conform to any preset format, and MOPS 101 may perform Natural Language Processing (“NLP”), artificial intelligence/machine learning (“AI/ML”) processing, regular expression matching, and/or other suitable types of processing or analysis in order to identify one or more service plans 301 that satisfy the request.

In some embodiments, MOPS 101 may select a “best” matching service plan 301 for the request and/or may otherwise rank or prioritize service plans 301, associated with network 103-2, based on the request. For example, a particular service plan 301 having a highest match or measure of similarity to the request may be a highest ranked service plan 301 out of the service plans 301 associated with network 103-2, a second service plan 301 having a second highest match or measure of similarity to the request may be a second highest ranked service plan 301 out of service plans 301, and so on.

In some embodiments, MOPS 101 may filter or omit service plans 301 for which UE 401 is ineligible and/or that otherwise do not satisfy the request. For example, if the request indicates that the requested service location is a location that is not associated with a particular service plan 301, then MOPS 101 may omit such service plan 301 when selecting or identifying plans that satisfy the request. As another example, if the request indicates a device type or device identifier that is not authorized for a given service plan 301, then MOPS 101 may omit such service plan 301 when selecting or identifying plans that satisfy the request.

In some embodiments, the request may be a request for any or all service plans 301 for which UE 401 is eligible. For example, such request may include an identifier of UE 401, and MOPS 101 may identify (at 504) all service plans 301 for which UE 401 is eligible, without regard to other service parameters (e.g., without regard to service parameters that are not specified in the request).

MOPS 101 may provide (at 506) an indication of the identified service plans 301, associated with network 103-2, for which UE 401 is eligible. For example, MOPS 101 may provide some or all of the service attributes of the identified service plans 301, identifiers or indicators of the identified service plans 301, tags or labels associated with the identified service plans 301, and/or other information associated with the identified service plans 301. In some embodiments, admin system 105-1 may present (e.g., via a graphical user interface (“GUI”) or other suitable presentation technique) some or all of the service plans 301, and a user of admin system 105-1 may select a particular service plan 301 from the provided set of service plans 301. Additionally, or alternatively, an application executing at admin system 105-1 may automatically select a particular service plan 301 from the set of provided service plans 301. In some embodiments, admin system 105-1 may select, or receive a selection, of a particular service plan 301 in some other suitable manner. Admin system 105-1 may provide (at 508) an indication of the selected service plan 301, associated with network 103-2, to MOPS 101.

FIG. 5B illustrates another example of MOPS 101 determining a particular service plan 301, associated with network 103-2, for which UE 401 should be provisioned. As shown, MOPS 101 may receive (at 510) a request to provision UE 401 to access network 103-2. As similarly discussed above, the request may include one or more identifiers of UE 401, one or more requested service parameters, and/or other suitable information. In some embodiments, the request may specify a particular service plan 301 associated with network 103-2 (e.g., may include a name, identifier, etc. of the particular service plan 301). For example, admin system 105-1 may be “aware” of service plans 301 associated with network 103-2, and may include an indication of a particular service plan 301 of the service plans 301 associated with network 103-2.

MOPS 101 may select (at 512) a particular service plan 301 based on the information provided in the request. As discussed above, for example, MOPS 101 may utilize NLP processing, AI/ML techniques, regular expression matching, and/or other suitable techniques to compare information provided in the request to service parameters and/or policies 201-2 associated with network 103-2. Based on the comparing, MOPS 101 may select a highest ranking or best-matching service plan 301 (e.g., without further input from admin system 105-1, such as in the example provided in FIG. 5A).

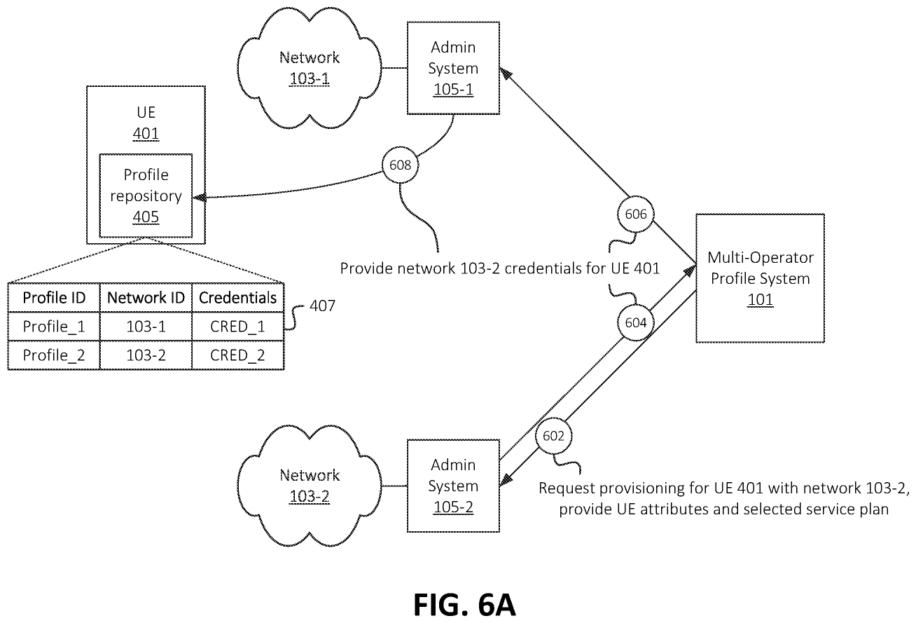

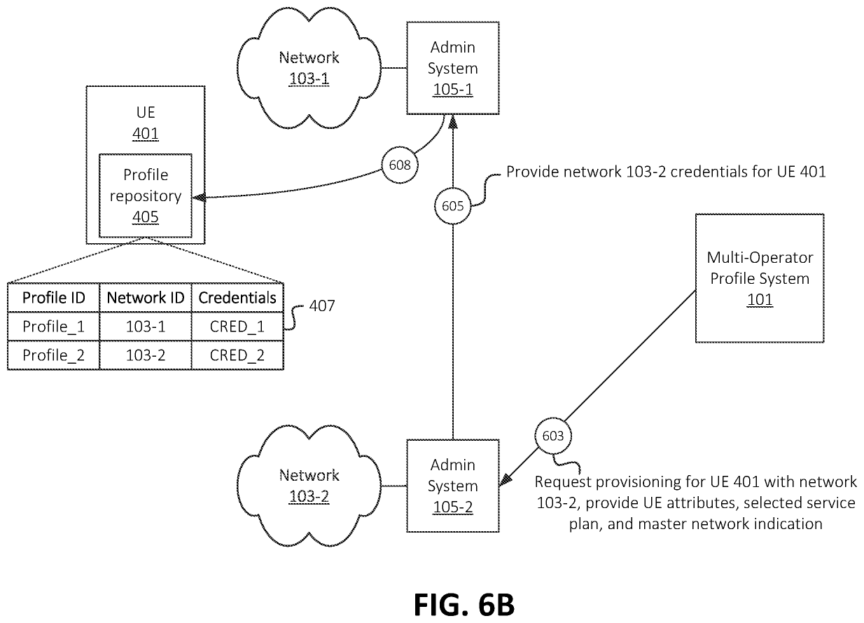

Once MOPS 101 has received (at 508) an indication of, or has selected (at 512) the particular service plan 301 to satisfy the request, MOPS 101 may, as shown in FIG. 6A, output (at 602) a request to admin system 105-2, associated with network 103-2, to provision UE 401 to access network 103-2. For example, MOPS 101 may provide (at 602) an identifier of UE 401 (e.g., an IMEI value or other suitable value), an indication of the selected (at 508 or 512) service plan 301, and/or other information that may be used by admin system 105-2 to provision UE 401.

In some embodiments, MOPS 101 may be configured to communicate with different admin systems 105, associated with different networks 103, according to particular protocols, messaging schemes, formats, data structures, etc. that are implemented by such admin systems 105. For example, as part of the registration of admin systems 105 with MOPS 101 (e.g., as discussed above with respect to FIG. 1) and/or in conjunction with some other procedure, MOPS 101 may receive information (e.g., from admin systems 105 and/or from some other source) indicating which particular protocols, messaging schemes, etc. are implemented by each respective admin system 105. Additionally, or alternatively, MOPS 101 may be associated with an API specifying particular formats, data structures, etc. of communications between MOPS 101 and respective admin systems 105. As such, in some embodiments, the request (at 602) may include one or more transcoded, translated, formatted, etc. messages generated by MOPS 101 based on the selection of a particular service plan 301 for UE 401 (e.g., transcoded, translated, etc. according to one or more protocols, messaging schemes, etc. associated with admin system 105-2. Additionally, or alternatively, the request (at 602) may be in a format associated with an API associated with MOPS 101, which may be implemented by admin system 105-2 in order to receive and fulfill the request.

Assuming that admin system 105-2 has authenticated the request and has verified that UE 401 is authorized to access network 103-2 via the selected service plan 301, admin system 105-2 may, as discussed above, generate or select a set of network credentials and/or identifiers (e.g., an IMSI value, a Mobile Station International Subscriber Directory Number (“MSISDN”), an MDN, etc.) that can be used by UE 401 to access network 103-2. Admin system 105-2 may perform other operations related to provisioning UE 401 to access network 103-2, such as updating a UDM, an HSS, and/or other elements of network 103-2 to allow UE 401 to communicate via network 103-2, establish communication sessions (e.g., protocol data unit (“PDU”) sessions, radio bearers, etc.) via network 103-2, or the like. Further, such elements of network 103-2 may be updated with an indication of the particular service plan 301 for which UE 401 has been provisioned. Such elements may accordingly provide service to UE 401 according to such service plan 301, which may include setting QoS parameters, queue weights, routing parameters, and/or other parameters in order to satisfy the service parameters of the particular service plan 301.

Admin system 105-2 may accordingly provide (at 604) the network credentials and/or identifiers to MOPS 101, which may forward (at 606) the network credentials and/or identifiers to admin system 105-1. In some embodiments, admin system 105-1 may provide (at 608) the network credentials and/or identifiers to UE 401, and/or some other suitable device or system may provide the network credentials and/or identifiers to UE 401. As discussed above, UE 401 may modify profile repository 405 (e.g., a SIM card, a UICC, an eSIM, etc.) to include the provided network credentials for network 103-2 (represented in the figure as “CRED_2”). In this manner, data structure 407, associated with profile repository 405, may include two different profiles (“Profile_1” and “Profile_2”) that are each associated with two different networks 103-1 and 103-2, respectively. As such, each different profile includes a distinct set of network credentials and/or identifiers.

In some embodiments, MOPS 101 may not receive (e.g., at 604) the network credentials from admin system 105-2. For example, as shown in FIG. 6B, admin system 105-2 may receive (at 603), along with the request to provision UE 401 for access to network 103-2, an indication of network 103-1 as a “master” network associated with UE 401. For example, as discussed above, MOPS 101 may maintain information indicating that network 103-1 is a master network with respect to UE 401, and may indicate, to admin system 105-2, that network 103-1 is a master network with respect to UE 401. For example, MOPS 101 may provide (at 603) a network identifier associated with network 103-1, an IP address or other locator information associated with admin system 105-1, and/or may otherwise indicate that network 103-1 is a master network with respect to UE 401.

Accordingly, after provisioning UE 401 for access to network 103-2, admin system 105-2 may provide (at 605) network credentials and/or identifiers, that may be used by UE 401 to access network 103-2, to admin system 105-1 (e.g., without providing the credentials, identifiers, etc. to MOPS 101). As discussed above, admin system 105-1 and/or some other device or system may provide (at 608) the credentials, identifiers, etc. to UE 401, which may modify profile repository 405 (e.g., data structure 407) to include a profile associated with network 103-2 and the associated credentials, identifiers, etc.

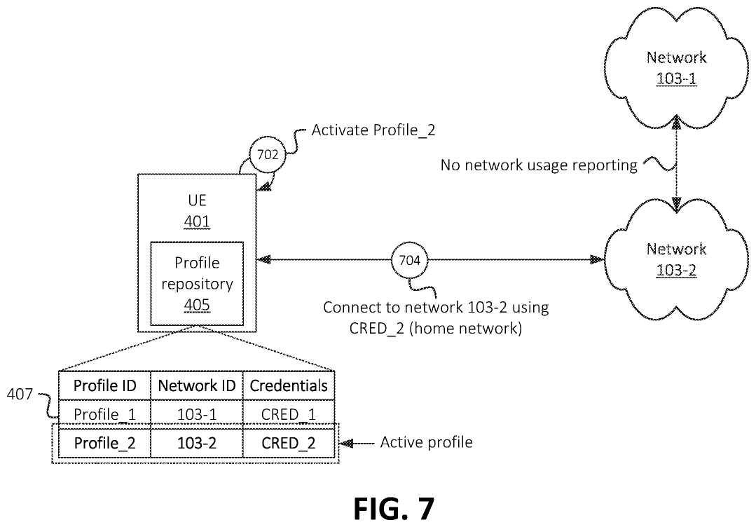

As discussed above, UE 401 may select an active profile, based on which UE 401 provides the associated set of network credentials and/or identifiers when attempting to access one or more networks 103. For example, as shown in FIG. 7, UE 401 may activate (at 702) Profile_2. The activation may be based on, for example, a user selection at UE 401 and/or may be automatically performed by UE 401 (e.g., based on one or more triggering events or conditions, such as location-based conditions, temporal conditions, or other types of events or conditions). UE 401 may accordingly use CRED_2 (e.g., associated with the activated Profile_2) to connect (at 704) to network 103-2. For example, UE 401 may provide an IMSI value, an MSISDN value, etc. (associated with CRED_2) when connecting to a RAN of network 103-2 and/or when requesting one or more sessions to be established with a core of network 103-2. Since the network credentials and/or identifiers associated with Profile_2 have been previously provisioned, provided, etc. by network 103-2, network 103-2 may grant access to UE 401 as a “home” network. Since the network 103-2 is a home network with respect to UE 401 (e.g., when Profile_2 is active), network 103-2 may not need to communicate with network 103-1 regarding the usage of network 103-2 by UE 401. For example, network 103-2 may maintain its own usage and/or charging system, and may track usage by UE 401 independently of network 103-1. As discussed above, network 103-2 may provide service to UE 401 in accordance with the particular service plan 301 (e.g., as indicated at 602) for which UE 401 has been provisioned.

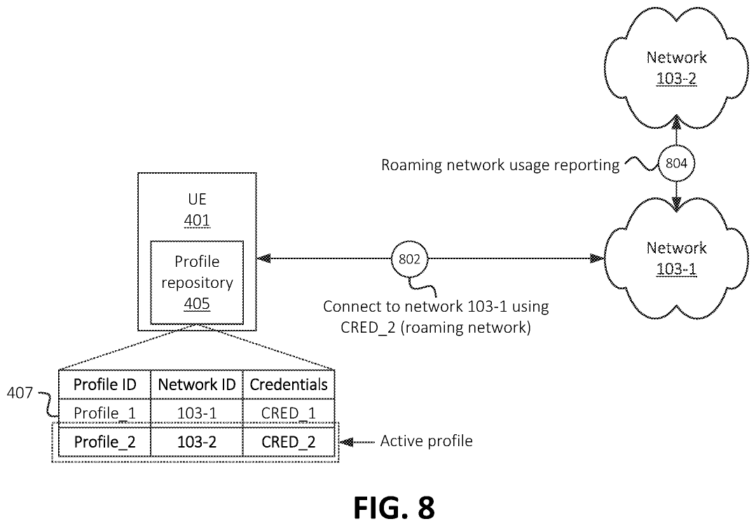

On the other hand, as shown in FIG. 8, when Profile_2 is the active profile and UE 401 connects (at 802) to network 103-1 (e.g., using CRED_2), network 103-1 may grant access to UE 401 as a roaming network. Granting access to UE 401 may include communicating (at 804) with network 103-2 (e.g., which may be identified based on the network credentials or other suitable information provided by UE 401 when connecting to network 103-1). Such communicating (at 804) may include communications related to granting access to UE 401, determining service parameters that UE 401 is authorized to access via network 103-1, providing usage reporting information to network 103-2 (e.g., where network 103-2 may ultimately generate usage reports or may generate charging information for UE 401), and/or other suitable communications.

In some embodiments, although examples described above are provided in the context of adding profiles, network credentials, etc. to UE 401, similar concepts may apply to removing or modifying such information at UE 401. For example, admin system 105-1 (e.g., a particular admin system 105 that is authorized to modify profile repository 405 of UE 401) may remove a particular profile or set of network credentials from profile repository 405, such as based on a selection by an administrator or operator associated with admin system 105-1 and/or based on an automatic determination (e.g., based on one or more conditions being satisfied, based on AI/ML processing, etc.) that such profile should be removed. Additionally, or alternatively, admin system 105-1 may modify information stored in profile repository 405, such as replacing a set of network credentials or identifiers, associated with one or more networks 103, with a different set of network credentials or identifiers. For example, a particular network 103 may provide updated network credentials, such as in situations where previously provided network credentials have been compromised or are otherwise no longer valid.

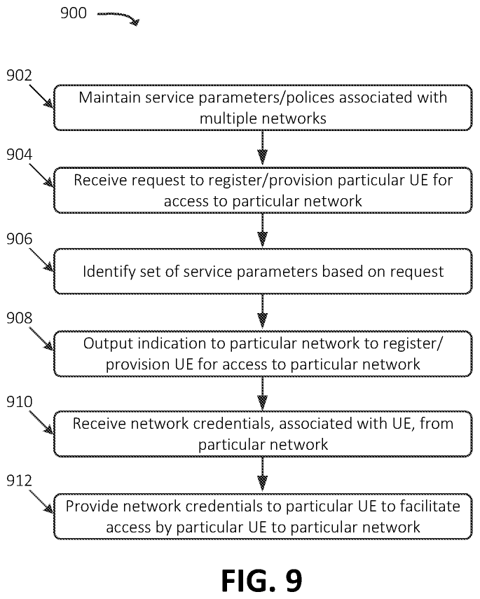

FIG. 9 illustrates an example process 900 for facilitating the provisioning of UE 401 with one or more networks 103. In some embodiments, some or all of process 900 may be performed by MOPS 101. In some embodiments, one or more other devices may perform some or all of process 900 in concert with, and/or in lieu of, MOPS 101, such as one or more admin systems 105 associated with one or more networks 103.

As shown, process 900 may include maintaining (at 902) respective sets of service parameters and/or policies (e.g., service parameters and/or policies 201) associated with multiple respective networks 103. As discussed above, service parameters and/or policies 201 may include one or more service plans 301, which may each be associated with a particular set of QoS parameters, location parameters, UE access policies (e.g., specifying particular UEs 401 and/or groups of UEs for which a particular set of service parameters are available), and/or other suitable information.

Process 900 may further include receiving (at 904) a request to register, provision, etc. a particular UE 401 for access to a particular network 103. For example, MOPS 101 may receive a request, from a particular admin system 105 and/or some other suitable (e.g., authorized) source, to register, provision, etc. UE 401 for access to the particular network 103. In some embodiments, MOPS 101 may verify that the request is received from an authorized source, such as a master network 103 (or master admin system 105) with respect to UE 401, as discussed above. The request may include one or more identifiers associated with UE 401, such as an IMEI value, a serial number, a hardware identifier, a non-portable identifier, and/or one or more other suitable identifiers. In some embodiments, as discussed above the request may include a set of requested service parameters (e.g., QoS parameters, location parameters, labels, tags, and/or other suitable information), and/or may indicate a particular service plan 301 associated with the particular network 103 for which provisioning is being requested.

Process 900 may additionally include identifying (at 906) a particular set of service parameters based on the request. For example, MOPS 101 may perform NLP processing, AI/ML processing, pattern matching, and/or other suitable techniques in order to identify a particular set of service parameters (e.g., a particular service plan 301 associated with the particular network 103 for which provisioning is being requested) that satisfies the request. As discussed above, MOPS 101 may identify that UE 401 is ineligible for one or more service plans 301 (e.g., based on policies associated with such service plans 301, such as UE group policies and/or other policies or criteria), and may forgo selecting such service plans 301. In some embodiments, as discussed above, MOPS 101 may present a list of candidate service plans 301 (e.g., to admin system 105, from which the request (at 904) was received), and may receive a selection of a particular service plan 301.

Process 900 may also include outputting (at 908) an indication, to the particular network 103, to register, provision, etc. UE 401 for access to network 103. For example, as discussed above, MOPS 101 may output (e.g., to a particular admin system 105 associated with network 103) a request, an instruction, an indication, etc. to register, provision, etc. UE 401 for access to network 103. MOPS 101 may provide, for example, one or more identifiers of UE 401 (e.g., an IMEI value, an identifier associated with profile repository 405 of UE 401, a hardware identifier, etc.), an indication of the identified (at 906) set of service parameters (e.g., a particular service plan 301), and/or other suitable information. As discussed above, network 103 (e.g., admin system 105) may select, generate, etc. a set of network credentials that may be used by UE 401 to access network 103. Network 103 may perform one or more other operations commensurate with register, provisioning, etc. UE 401 for access, such as updating a UDM, HSS, and/or other network element with information associating UE 401 with the set of network credentials and the indicated service plan 301.

Process 900 may further include receiving (at 910) the network credentials from network 103. For example, MOPS 101 may receive the network credentials from admin system 105, associated with network 103, and may output (at 912) the network credentials, such that UE 401 receives the network credentials and is able to use such network credentials (e.g., when accessing the particular network 103 and/or one or more other networks). For example, as discussed above, MOPS 101 may provide the network credentials to a “master” network associated with UE 401, and/or may indicate the master network to the particular network 103 for which provisioning is being requested. As such, when UE 401 utilizes such network credentials to access the particular network 103, the particular network 103 may identify the particular service parameters (e.g., service plan 301) associated with UE 401, and may provide service in accordance with such service parameters (e.g., may implement QoS parameters, routing parameters, access control parameters, and/or other parameters associated with service plan 301) to UE 401.

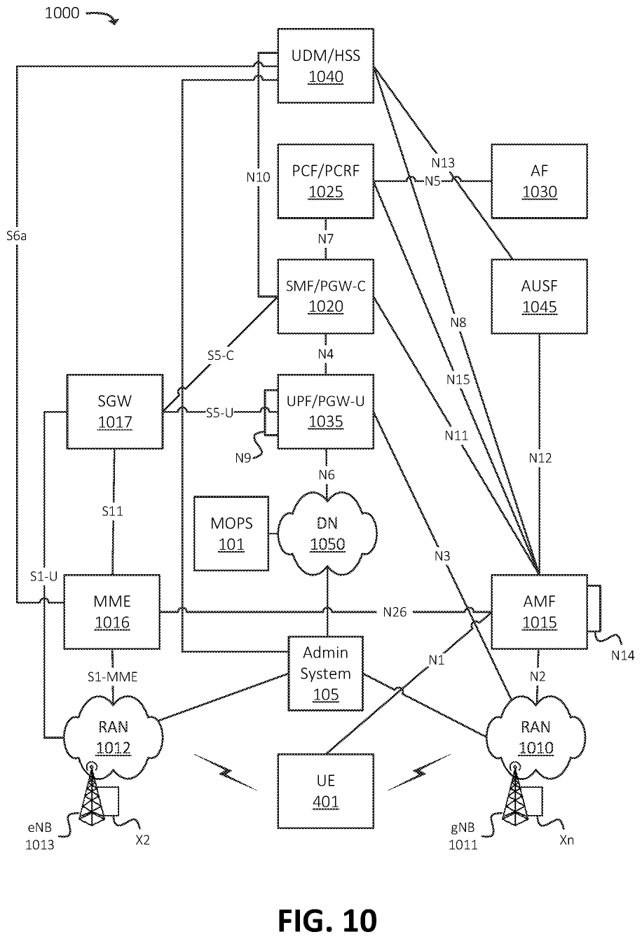

FIG. 10 illustrates an example environment 1000, in which one or more embodiments may be implemented. In some embodiments, environment 1000 may correspond to a 5G network, and/or may include elements of a 5G network. In some embodiments, environment 1000 may correspond to a 5G Non-Standalone (“NSA”) architecture, in which a 5G radio access technology (“RAT”) may be used in conjunction with one or more other RATs (e.g., an LTE RAT), and/or in which elements of a 5GC may be implemented by, may be communicatively coupled with, and/or may include elements of another type of core network (e.g., an EPC). In some embodiments, portions of environment 1000 may represent or may include a 5GC. As shown, environment 1000 may include UE 401, RAN 1010 (which may include one or more Next Generation Node Bs (“gNBs”) 1011), RAN 1012 (which may include one or more evolved Node Bs (“eNBs”) 1013), and various network functions such as Access and Mobility Management Function (“AMF”) 1015, Mobility Management Entity (“MME”) 1016, Serving Gateway (“SGW”) 1017, Session Management Function (“SMF”)/Packet Data Network (“PDN”) Gateway (“PGW”)-Control plane function (“PGW-C”) 1020, Policy Control Function (“PCF”)/Policy Charging and Rules Function (“PCRF”) 1025, Application Function (“AF”) 1030, User Plane Function (“UPF”)/PGW-User plane function (“PGW-U”) 1035, Unified Data Management (“UDM”)/Home Subscriber Server (“HSS”) 1040, and Authentication Server Function (“AUSF”) 1045. Environment 1000 may also include one or more networks, such as Data Network (“DN”) 1050. Environment 1000 may include one or more additional devices or systems communicatively coupled to one or more networks (e.g., DN 1050), such as MOPS 101 and/or admin system 105.

The example shown in FIG. 10 illustrates one instance of each network component or function (e.g., one instance of SMF/PGW-C 1020, PCF/PCRF 1025, UPF/PGW-U 1035, UDM/HSS 1040, and/or AUSF 1045). In practice, environment 1000 may include multiple instances of such components or functions. For example, in some embodiments, environment 1000 may include multiple “slices” of a core network, where each slice includes a discrete and/or logical set of network functions (e.g., one slice may include a first instance of SMF/PGW-C 1020, PCF/PCRF 1025, UPF/PGW-U 1035, UDM/HSS 1040, and/or AUSF 1045, while another slice may include a second instance of SMF/PGW-C 1020, PCF/PCRF 1025, UPF/PGW-U 1035, UDM/HSS 1040, and/or AUSF 1045). The different slices may provide differentiated levels of service, such as service in accordance with different Quality of Service (“QoS”) parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. Alternatively, or additionally, one or more of the devices of environment 1000 may perform one or more network functions described as being performed by another one or more of the devices of environment 1000. Devices of environment 1000 may interconnect with each other and/or other devices via wired connections, wireless connections, or a combination of wired and wireless connections. In some implementations, one or more devices of environment 1000 may be physically integrated in, and/or may be physically attached to, one or more other devices of environment 1000. In some embodiments, environment 1000 may be, may include, may be implemented by, and/or may be communicatively coupled to a particular network 103.

UE 401 may include a computation and communication device, such as a wireless mobile communication device that is capable of communicating with RAN 1010, RAN 1012, and/or DN 1050. UE 401 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 401 may send traffic to and/or receive traffic (e.g., user plane traffic) from DN 1050 via RAN 1010, RAN 1012, and/or UPF/PGW-U 1035.

RAN 1010 may be, or may include, a 5G RAN that includes one or more base stations (e.g., one or more gNBs 1011), via which UE 401 may communicate with one or more other elements of environment 1000. UE 401 may communicate with RAN 1010 via an air interface (e.g., as provided by gNB 1011). For instance, RAN 1010 may receive traffic (e.g., user plane traffic such as voice call traffic, data traffic, messaging traffic, etc.) from UE 401 via the air interface, and may communicate the traffic to UPF/PGW-U 1035 and/or one or more other devices or networks. Further, RAN 1010 may receive signaling traffic, control plane traffic, etc. from UE 401 via the air interface, and may communicate such signaling traffic, control plane traffic, etc. to AMF 1015 and/or one or more other devices or networks. Additionally, RAN 1010 may receive traffic intended for UE 401 (e.g., from UPF/PGW-U 1035, AMF 1015, and/or one or more other devices or networks) and may communicate the traffic to UE 401 via the air interface.

RAN 1012 may be, or may include, a LTE RAN that includes one or more base stations (e.g., one or more eNBs 1013), via which UE 401 may communicate with one or more other elements of environment 1000. UE 401 may communicate with RAN 1012 via an air interface (e.g., as provided by eNB 1013). For instance, RAN 1012 may receive traffic (e.g., user plane traffic such as voice call traffic, data traffic, messaging traffic, signaling traffic, etc.) from UE 401 via the air interface, and may communicate the traffic to UPF/PGW-U 1035 (e.g., via SGW 1017) and/or one or more other devices or networks. Further, RAN 1012 may receive signaling traffic, control plane traffic, etc. from UE 401 via the air interface, and may communicate such signaling traffic, control plane traffic, etc. to MME 1016 and/or one or more other devices or networks. Additionally, RAN 1012 may receive traffic intended for UE 401 (e.g., from UPF/PGW-U 1035, MME 1016, SGW 1017, and/or one or more other devices or networks) and may communicate the traffic to UE 401 via the air interface.

AMF 1015 may include one or more devices, systems, Virtualized Network Functions (“VNFs”), Cloud-Native Network Functions (“CNFs”), etc., that perform operations to register UE 401 with the 5G network, to establish bearer channels associated with a session with UE 401, to hand off UE 401 from the 5G network to another network, to hand off UE 401 from the other network to the 5G network, manage mobility of UE 401 between RANs 1010 and/or gNBs 1011, and/or to perform other operations. In some embodiments, the 5G network may include multiple AMFs 1015, which communicate with each other via the N14 interface (denoted in FIG. 10 by the line marked “N14” originating and terminating at AMF 1015).

MME 1016 may include one or more devices, systems, VNFs, CNFs, etc., that perform operations to register UE 401 with the EPC, to establish bearer channels associated with a session with UE 401, to hand off UE 401 from the EPC to another network, to hand off UE 401 from another network to the EPC, manage mobility of UE 401 between RANs 1012 and/or eNBs 1013, and/or to perform other operations.

SGW 1017 may include one or more devices, systems, VNFs, CNFs, etc., that aggregate traffic received from one or more eNBs 1013 and send the aggregated traffic to an external network or device via UPF/PGW-U 1035. Additionally, SGW 1017 may aggregate traffic received from one or more UPF/PGW-Us 1035 and may send the aggregated traffic to one or more eNBs 1013. SGW 1017 may operate as an anchor for the user plane during inter-eNB handovers and as an anchor for mobility between different telecommunication networks or RANs (e.g., RANs 1010 and 1012).

SMF/PGW-C 1020 may include one or more devices, systems, VNFs, CNFs, etc., that gather, process, store, and/or provide information in a manner described herein. SMF/PGW-C 1020 may, for example, facilitate the establishment of communication sessions on behalf of UE 401. In some embodiments, the establishment of communications sessions may be performed in accordance with one or more policies provided by PCF/PCRF 1025.

PCF/PCRF 1025 may include one or more devices, systems, VNFs, CNFs, etc., that aggregate information to and from the 5G network and/or other sources. PCF/PCRF 1025 may receive information regarding policies and/or subscriptions from one or more sources, such as subscriber databases and/or from one or more users (such as, for example, an administrator associated with PCF/PCRF 1025).

AF 1030 may include one or more devices, systems, VNFs, CNFs, etc., that receive, store, and/or provide information that may be used in determining parameters (e.g., quality of service parameters, charging parameters, or the like) for certain applications.

UPF/PGW-U 1035 may include one or more devices, systems, VNFs, CNFs, etc., that receive, store, and/or provide data (e.g., user plane data). For example, UPF/PGW-U 1035 may receive user plane data (e.g., voice call traffic, data traffic, etc.), destined for UE 401, from DN 1050, and may forward the user plane data toward UE 401 (e.g., via RAN 1010, SMF/PGW-C 1020, and/or one or more other devices). In some embodiments, multiple UPFs 1035 may be deployed (e.g., in different geographical locations), and the delivery of content to UE 401 may be coordinated via the N9 interface (e.g., as denoted in FIG. 10 by the line marked “N9” originating and terminating at UPF/PGW-U 1035). Similarly, UPF/PGW-U 1035 may receive traffic from UE 401 (e.g., via RAN 1010, RAN 1012, SMF/PGW-C 1020, and/or one or more other devices), and may forward the traffic toward DN 1050. In some embodiments, UPF/PGW-U 1035 may communicate (e.g., via the N4 interface) with SMF/PGW-C 1020, regarding user plane data processed by UPF/PGW-U 1035.

UDM/HSS 1040 and AUSF 1045 may include one or more devices, systems, VNFs, CNFs, etc., that manage, update, and/or store, in one or more memory devices associated with AUSF 1045 and/or UDM/HSS 1040, profile information associated with a subscriber. AUSF 1045 and/or UDM/HSS 1040 may perform authentication, authorization, and/or accounting operations associated with the subscriber and/or a communication session with UE 401.

DN 1050 may include one or more wired and/or wireless networks. For example, DN 1050 may include an Internet Protocol (“IP”)-based PDN, a wide area network (“WAN”) such as the Internet, a private enterprise network, and/or one or more other networks. UE 401 may communicate, through DN 1050, with data servers, other UEs 401, and/or to other servers or applications that are coupled to DN 1050. DN 1050 may be connected to one or more other networks, such as a public switched telephone network (“PSTN”), a public land mobile network (“PLMN”), and/or another network. DN 1050 may be connected to one or more devices, such as content providers, applications, web servers, and/or other devices, with which UE 401 may communicate.

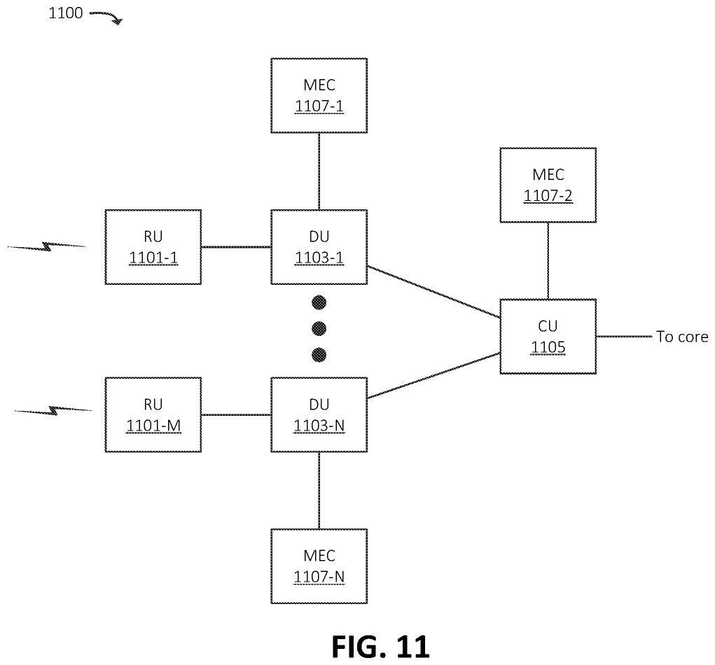

FIG. 11 illustrates an example RAN environment 1100, which may be included in and/or implemented by one or more RANs (e.g., RAN 1010, RAN 1012, or some other RAN). In some embodiments, a particular RAN may include one RAN environment 1100. In some embodiments, a particular RAN may include multiple RAN environments 1100. In some embodiments, RAN environment 1100 may correspond to a particular gNB 1011 of a 5G RAN (e.g., RAN 1010). In some embodiments, RAN environment 1100 may correspond to multiple gNBs 1011. In some embodiments, RAN environment 1100 may correspond to one or more other types of base stations of one or more other types of RANs. As shown, RAN environment 1100 may include Central Unit (“CU”) 1105, one or more Distributed Units (“DUs”) 1103-1 through 1103-N (referred to individually as “DU 1103,” or collectively as “DUs 1103”), and one or more Radio Units (“RUs”) 1101-1 through 1101-M (referred to individually as “RU 1101,” or collectively as “RUs 1101”).

CU 1105 may communicate with a core of a wireless network (e.g., may communicate with one or more of the devices or systems described above with respect to FIG. 10, such as AMF 1015 and/or UPF/PGW-U 1035). In the uplink direction (e.g., for traffic from UEs 401 to a core network), CU 1105 may aggregate traffic from DUs 1103, and forward the aggregated traffic to the core network. In some embodiments, CU 1105 may receive traffic according to a given protocol (e.g., Radio Link Control (“RLC”)) from DUs 1103, and may perform higher-layer processing (e.g., may aggregate/process RLC packets and generate Packet Data Convergence Protocol (“PDCP”) packets based on the RLC packets) on the traffic received from DUs 1103.

In accordance with some embodiments, CU 1105 may receive downlink traffic (e.g., traffic from the core network) for a particular UE 401, and may determine which DU(s) 1103 should receive the downlink traffic. DU 1103 may include one or more devices that transmit traffic between a core network (e.g., via CU 1105) and UE 401 (e.g., via a respective RU 1101). DU 1103 may, for example, receive traffic from RU 1101 at a first layer (e.g., physical (“PHY”) layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 401.

RU 1101 may include hardware circuitry (e.g., one or more RF transceivers, antennas, radios, and/or other suitable hardware) to communicate wirelessly (e.g., via an RF interface) with one or more UEs 401, one or more other DUs 1103 (e.g., via RUs 1101 associated with DUs 1103), and/or any other suitable type of device. In the uplink direction, RU 1101 may receive traffic from UE 401 and/or another DU 1103 via the RF interface and may provide the traffic to DU 1103. In the downlink direction, RU 1101 may receive traffic from DU 1103, and may provide the traffic to UE 401 and/or another DU 1103.

One or more elements of RAN environment 1100 may, in some embodiments, be communicatively coupled to one or more Multi-Access/Mobile Edge Computing (“MEC”) devices, referred to sometimes herein simply as “MECs” 1107. For example, DU 1103-1 may be communicatively coupled to MEC 1107-1, DU 1103-N may be communicatively coupled to MEC 1107-N, CU 1105 may be communicatively coupled to MEC 1107-2, and so on. MECs 1107 may include hardware resources (e.g., configurable or provisionable hardware resources) that may be configured to provide services and/or otherwise process traffic to and/or from UE 401, via a respective RU 1101.

For example, DU 1103-1 may route some traffic, from UE 401, to MEC 1107-1 instead of to a core network via CU 1105. MEC 1107-1 may process the traffic, perform one or more computations based on the received traffic, and may provide traffic to UE 401 via RU 1101-1. In some embodiments, MEC 1107 may include, and/or may implement, some or all of the functionality described above with respect to MOPS 101, admin system 105, AF 1030, UPF 1035, and/or one or more other devices, systems, VNFs, CNFs, etc. In this manner, ultra-low latency services may be provided to UE 401, as traffic does not need to traverse DU 1103, CU 1105, links between DU 1103 and CU 1105, and an intervening backhaul network between RAN environment 1100 and the core network.

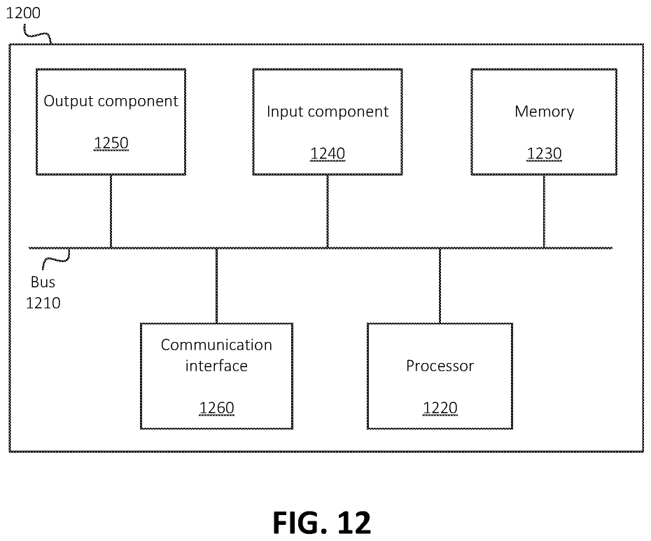

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, or processing logic that may interpret and execute instructions. In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to input component 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems. For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1200 may include more than one communication interface 1260. For instance, device 1200 may include an optical interface and an Ethernet interface.

Device 1200 may perform certain operations relating to one or more processes described above. Device 1200 may perform these operations in response to processor 1220 executing software instructions stored in a computer-readable medium, such as memory 1230. A computer-readable medium may be defined as a non-transitory memory device. A memory device may include space within a single physical memory device or spread across multiple physical memory devices. The software instructions may be read into memory 1230 from another computer-readable medium or from another device. The software instructions stored in memory 1230 may cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-9), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one.” “single.” “only.” or similar language is used. Further, the phrase “based on” is intended to mean “based, at least in part, on” unless explicitly stated otherwise.

What is claimed is:

1. A device, comprising:
one or more processors configured to:
maintain a plurality of sets of service parameters associated with a plurality of networks;
receive a request to register a User Equipment (“UE”) with a particular network, of the plurality of networks, wherein the request includes an identifier of the UE;
identify, based on the request, a particular set of service parameters, from a particular plurality of sets of service parameters associated with the particular network; and
output an indication, to a system associated with the particular network, indicating the identifier of the UE and the identified particular set of service parameters,
wherein the system selects or generates a set of network credentials based on receiving the indication,
wherein the UE uses the set of network credentials to access the particular network, and
wherein the particular network provides service to the UE in accordance with the particular set of service parameters.

2. The device of claim 1, wherein the request includes a set of query terms, wherein identifying the particular set of service parameters includes identifying the particular set of service parameters based on the set of query terms.

3. The device of claim 2, wherein identifying the particular set of service parameters based on the set of query terms includes utilizing at least one of:
artificial intelligence/machine learning (“AI/ML”) techniques, or
natural language processing (“NLP”) techniques.

4. The device of claim 1, wherein the particular set of service parameters includes a set of Quality of Service (“QoS”) parameters.

5. The device of claim 1, wherein the plurality of networks are associated with a plurality of different network operators.

6. The device of claim 1, wherein the request is received from a master network associated with the UE, wherein the one or more processors are further configured to:
receive, from the particular network, the set of network credentials; and
output the set of network credentials to the master network, wherein the master network forwards the set of network credentials to the UE.

7. The device of claim 1, wherein the UE includes a profile repository that maintains one or more profiles that are each associated with one or more respective network credentials, wherein the UE adds the set of network credentials to the profile repository.

8. A non-transitory computer-readable medium, storing a plurality of processor-executable instructions to:
maintain a plurality of sets of service parameters associated with a plurality of networks;
receive a request to register a User Equipment (“UE”) with a particular network, of the plurality of networks, wherein the request includes an identifier of the UE;
identify, based on the request, a particular set of service parameters, from a particular plurality of sets of service parameters associated with the particular network; and
output an indication, to a system associated with the particular network, indicating the identifier of the UE and the identified particular set of service parameters,
wherein the system selects or generates a set of network credentials based on receiving the indication,
wherein the UE uses the set of network credentials to access the particular network, and
wherein the particular network provides service to the UE in accordance with the particular set of service parameters.

9. The non-transitory computer-readable medium of claim 8, wherein the request includes a set of query terms, wherein identifying the particular set of service parameters includes identifying the particular set of service parameters based on the set of query terms.

10. The non-transitory computer-readable medium of claim 9, wherein identifying the particular set of service parameters based on the set of query terms includes utilizing at least one of:
artificial intelligence/machine learning (“AI/ML”) techniques, or
natural language processing (“NLP”) techniques.

11. The non-transitory computer-readable medium of claim 8, wherein the particular set of service parameters includes a set of Quality of Service (“QoS”) parameters.

12. The non-transitory computer-readable medium of claim 8, wherein the plurality of networks are associated with a plurality of different network operators.

13. The non-transitory computer-readable medium of claim 8, wherein the request is received from a master network associated with the UE, wherein the plurality of processor-executable instructions further include processor-executable instructions to:
receive, from the particular network, the set of network credentials; and
output the set of network credentials to the master network, wherein the master network forwards the set of network credentials to the UE.

14. The non-transitory computer-readable medium of claim 8, wherein the UE includes a profile repository that maintains one or more profiles that are each associated with one or more respective network credentials, wherein the UE adds the set of network credentials to the profile repository.

15. A method, comprising:
maintaining a plurality of sets of service parameters associated with a plurality of networks;
receiving a request to register a User Equipment (“UE”) with a particular network, of the plurality of networks, wherein the request includes an identifier of the UE;
identifying, based on the request, a particular set of service parameters, from a particular plurality of sets of service parameters associated with the particular network; and
outputting an indication, to a system associated with the particular network, indicating the identifier of the UE and the identified particular set of service parameters,
wherein the system selects or generates a set of network credentials based on receiving the indication,
wherein the UE uses the set of network credentials to access the particular network, and
wherein the particular network provides service to the UE in accordance with the particular set of service parameters.

16. The method of claim 15, wherein the request includes a set of query terms, wherein identifying the particular set of service parameters includes identifying the particular set of service parameters based on the set of query terms.

17. The method of claim 15, wherein the particular set of service parameters includes a set of Quality of Service (“QoS”) parameters.

18. The method of claim 15, wherein the plurality of networks are associated with a plurality of different network operators.

19. The method of claim 15, wherein the request is received from a master network associated with the UE, the method further comprising:
receiving, from the particular network, the set of network credentials; and
outputting the set of network credentials to the master network, wherein the master network forwards the set of network credentials to the UE.

20. The method of claim 15, wherein the UE includes a profile repository that maintains one or more profiles that are each associated with one or more respective network credentials, wherein the UE adds the set of network credentials to the profile repository.
